(19) United States
(12) Patent Application Publication
(10) Pub. No.: US 2014/0278622 A1
(43) Pub. Date: Sep. 18, 2014

(54) ITERATIVE PROCESS FOR LARGE SCALE MARKETING SPEND OPTIMIZATION

(71) Applicant: MARKETSHARE PARTNERS LLC, Santa Monica, CA (US)

(72) Inventors: Huigang Chen, Riverside, CA (US); Neil Morley, Santa Monica, CA (US); Ashok Patel, Los Angeles, CA (US); Ilgaz Sungur, Venice, CA (US); Phil Weissman, Brooklyn, CA (US)

(21) Appl. No.: 13/837,785

(22) Filed: Mar. 15, 2013

(51) Int. Cl. G06Q 30/02

(52) U.S. Cl. CPC G06Q 30/0201
USPC 705/7.12; 705/7.31

(57) ABSTRACT

A facility comprising systems and methods for calculating, for a given budget, an allocation of resources to improve a particular outcome, such as revenue, profit, target miss, etc. The facility takes advantage of first-order derivate information and can decrease both the computation time and memory use in the calculation of suggested spends or allocations, such as the amount of marketing resources to be allocated to various marketing channels. The facility comprises techniques for 1) determining, for a given budget and a response model, resource allocations that will improve the modeled business outcome, 2) determining, for a given budget and revenue response model, resource allocations that will increase profits, and 3) determining, for a given budget, a given set of revenue response models, and a given set of revenue targets, resource allocations that will reduce total target misses.

### CROSS-REFERENCE TO RELATED APPLICATIONS

This application is related to U.S. patent application Ser. No. 12/390,341, filed Feb. 20, 2009, which claims the benefit of the following U.S. Provisional Patent Application Nos. 1) 61/030,550, filed Feb. 21, 2008, 2) 61/084,252, filed Jul. 28, 2008, 3) 61/084,255, filed Jul. 28, 2008, 4) 61/085,819, filed Aug. 1, 2008, and 5) 61/085,820, filed Aug. 1, 2008, is further related to U.S. patent application Ser. No. 12/366,937, filed Feb. 6, 2009, U.S. patent application Ser. No. 12/366,958, filed Feb. 6, 2009, U.S. patent application Ser. No. 12/692,577, filed Jan. 22, 2010, which claims the benefit of U.S. Provisional Patent Application No. 61/146,605, filed Jan. 22, 2009, U.S. patent application Ser. No. 12/692,579, filed Jan. 22, 2010, which claims the benefit of U.S. Provisional Patent Application No. 61/146,605, filed Jan. 22, 2009, U.S. patent application Ser. No. 12/692,580, filed Jan. 22, 2010, which claims the benefit of U.S. Provisional Patent Application No. 61/146,605, filed Jan. 22, 2009, U.S. patent application Ser. No. 12/609,440, filed Oct. 30, 2009, and U.S. patent application Ser. No. 13/204,585, filed Aug. 5, 2011. All of the above-identified patent applications are incorporated in their entirety herein by reference. To the extent that the foregoing applications and/or any other materials incorporated herein by reference conflict with the present disclosure, the present disclosure controls.

### BACKGROUND

Marketing communication (“marketing”) is the process by which sellers of a product or a service—i.e., an “offering”—educate potential purchasers or consumers about the offering through, for example, the dissemination of advertisements or marketing messages. Marketing can be a major expense for sellers, and often comprises a large number of components or categories, such as different marketing media (e.g., online, radio, outdoor, television (cable, broadcast, satellite, etc.), display, video games (casual, console, online, MMORPGs, etc.), print, cell phones, personal digital assistants, email, digital video recorders), as well as various marketing techniques, such as direct marketing, promotions, product placement, etc. Furthermore, each marketing medium may include multiple types of marketing outlets or touchpoints—i.e., “channels”—such as advertising networks, advertising exchanges, search engines, websites, online video sites, television networks, television programs, timeslots for each television network, specific newspapers, specific sections within newspapers, specific sections within specific newspapers, and so on. Moreover, each marketing medium may be further broken down by cross-section based on, for example, demographics, regions, products, segments, or other factors. The proliferation of multiple new and unique media channels has made the task of assessing the relationship between marketing campaigns, marketing channels, and user behavior even more difficult.

A response model or function relates a plurality of inputs to an output. For example, a revenue response model may relate a plurality of inputs, such as resource allocations and timing information to revenue. As another example, a marketing response model or function relates various types of marketing spend categories and their associated allocations (spends) (i.e., a “marketing mix”) (the input) to a business outcome (the output), such as revenue, profit, sales, target miss, and so on. A marketing response model describes the impact of allocating resources to different types of marketing media and/or outlets (e.g., TV, NBC, online advertisements, ADWORDS™, email, etc.) on one or more business outcomes. For example, a revenue response model defined as revenue=F(X₁, . . . , Xₙ) relates revenue to n marketing spends X₁, . . . , Xₙ, where each marketing spend represents an allocation of resources to a particular spend category or marketing channel (e.g., TV, NBC, online, NBC on the west coast of the United States between 5 pm to 8 pm) and the amount of resources (e.g., money) allocated to that marketing channel. In other words, function F takes as inputs independent variables X to provide a value for dependent variable revenue. Response models may be generated for other business outcomes as well, such as sales, profits, and so on. Moreover, response models at varying levels of granularity can be generated, such as a revenue response model for revenue generated in a particular geographic location (e.g., city, state, county, ZIP code, country) or a response model for a particular type of revenue (e.g., revenue from online purchases, revenue from in-store purchases, and so on).

In a marketing response model, each marketing channel has an associated “elasticity” that represents the effect that allocations to that channel have on the outcome, such as the percentage of change in an outcome due to the percentage of change in allocation to the channel. Thus, changes in resource allocation to one marketing channel may have a different (e.g., greater or smaller) effect on the outcome than changes to another marketing channel. Moreover, changes in a resource allocation to one marketing channel may affect the elasticity (upward or downward) for that marketing channel and/or elasticities for one or more other marketing channels. In other words, changes in a resource allocation to one marketing channel can have ripple effects and change how allocations to other channels affect business outcomes. Thus, it can be difficult to find the right balance of allocations to improve business outcomes.

A company or other entity may place budget limits or constraints on the amount of resources that can be allocated to marketing efforts. The constraints can pertain to an individual marketing channel or some combination of marketing channels. For example, a company may decide that at least $100,000 should be allocated to marketing but no more than $500,000 (i.e.,

$$\$100 \text{,} 000 \leq {\sum }_{i = 1}^{n} {X}_{i} \leq \$500 \text{,} 000 ) .$$

The company may further specify constraints for individual spends or other combinations, such as no more than $200,000 on online search advertisements (osa) (i.e., $0≦Xₒₛₐ≦$200,000) and at least $50,000 but no more than $300,000 on the combination of online search advertisements and email advertisements (i.e., $50,000≦Xₒₛₐ+Xₑₘₐᵢₗ≦$300,000). Furthermore, these constraints can be combined into a set of constraints.

Given a marketing spend budget, a marketing executive or other professional typically desires to find spending strategies that will provide the greatest results with respect to a business outcome. For example, a marketing professional may desire to ascertain and adopt the marketing spend that will provide the greatest revenue for a given budget. In other words, the marketing professional desires to make the most out of, or optimize, their marketing resources. Because marketing resources can be allocated to thousands and thousands of touchpoints, the marketing professional may use marketing spend optimization tools to find the best allocation of resources (i.e., marketing mix). Marketing mix optimization problems typically involve complex nonlinear models and a large number of variables and constraints, which pose a significant problem for marketing optimization tools. Moreover, typical marketing spend optimization tools rely on second-order derivative techniques, resulting in slow computation time and high memory use. Polynomial time second-order interior-point methods, for example, operate poorly on large scale nonlinear problems.

### BRIEF DESCRIPTION OF THE DRAWINGS

FIG. 1 is a block diagram illustrating an environment in which a facility in accordance with an embodiment of the disclosed technology may operate.

FIG. 2A is a data structure diagram illustrating a set of constraints in accordance with an embodiment of the disclosed technology.

FIG. 2B is a flow diagram illustrating the processing of a construct constraint tree component in accordance with an embodiment of the disclosed technology.

FIG. 2C is a display diagram illustrating a constraint tree in accordance with an embodiment of the disclosed technology.

FIG. 3 is a flow diagram illustrating the processing of an allocate component in accordance with an embodiment of the disclosed technology.

FIG. 4 is a flow diagram illustrating the processing of an approximate component in accordance with an embodiment of the disclosed technology.

FIG. 5 is a flow diagram illustrating the processing of a profit component in accordance with an embodiment of the disclosed technology.

FIG. 6 is a flow diagram illustrating the processing of a hit-target component in accordance with an embodiment of the disclosed technology.

FIG. 7 is a flow diagram illustrating the processing of a gradient descent component in accordance with an embodiment of the disclosed technology.

FIG. 8 is a flow diagram illustrating the processing of a bundle level component in accordance with an embodiment of the disclosed technology.

### DETAILED DESCRIPTION

A facility comprising improved systems and methods for calculating, for a given budget, an allocation of resources to improve a particular outcome, such as revenue, profit, target miss, etc., is provided. The facility takes advantage of first-order derivate information and can decrease both computation time and memory use in the calculation of suggested spends or allocations, such as the amount of marketing resources to be allocated to various marketing channels. The facility comprises techniques for 1) determining, for a given budget and a response model, resource allocations that will improve the modeled business outcome, 2) determining, for a given budget and revenue response model, resource allocations that will increase profits, and 3) determining, for a given budget, a given set of revenue response models, and a given set of revenue targets, resource allocations that will reduce total target misses (i.e., the lesser of zero and the difference between a revenue target and the revenue determined by the model) for a set of revenue types or sources. In some embodiments, the generated allocations or spends are constrained to the set of allocations or spends that are consistent with a defined set of constraints. The disclosed techniques can be invoked periodically (e.g., hourly, daily, weekly, monthly, quarterly, yearly) to provide regular and dynamic updates to resource allocations based at least in part on current model data.

In some embodiments, the facility iteratively applies the Dorfman-Steiner rule or its variants—which states that an optimal level of advertising occurs when the ratio of advertising to sales is equal to the ratio of the advertising elasticities to the price elasticity or some function of them—to find an allocation of resources that will improve or optimize a particular business outcome based at least in part on a response model for that outcome. Starting with a set of spends (i.e., resource allocations), such as a company's current allocation of marketing resources, the facility solves, at each iteration, an approximation of a response model, such as a Cobb-Douglas approximation model (or its variants), or other suitable approximation models, based at least in part on the spends and their associated elasticities. The “solution” to the approximation is another set of spends that improves the predicted outcome of the response model. If a newly generated set of spends does not improve a predicted outcome over a previous sets of spends beyond a predetermined threshold, then the new set of spends is provided as an optimal (or near optimal) set of spends for the particular business outcome. The predetermined threshold can be specified, for example, by a user or by the facility. The nearer the predetermined threshold is to zero, the more likely a final set of new spends will correspond to an optimal allocation. “Near optimal” refers to an improvement between spends that satisfies the predetermined threshold. The new spends can then be employed to improve the relevant business outcome. For example, the facility may determine that a company currently allocating 30% of its marketing budget to television and 70% of its marketing budget to online marketing would find better results (e.g., increased revenue) if the company were to allocate 50% of its marketing budget to television marketing and 50% to online marketing. Assuming that the response model and elasticities are non-decreasing, spends generated by each iteration will provide a better solution than the set of spends generated by a previous iteration. Accordingly, each generated set of spends can be further processed to find another improved set of spends.

In some embodiments, the facility determines an allocation of resources that will provide an optimal (or near optimal) level of profits (revenue minus costs) for a given set of constraints and revenue response model. The facility initially creates a “fake” or “dummy” spend corresponding to resources that are effectively “saved” or not allocated to marketing efforts. Rather, these resources are, for the sake of the response model, allocated to or “spent on” a marketing budget surplus. The facility then updates the constraints to take into account the fake spend by, for example, constraining the sum of all marketing spends and the fake spend to the upper bound on spends (e.g., a marketing budget). For example, the constraint

$$\$100 \text{,} 000 \leq {\sum }_{i = 1}^{n} {X}_{i} \leq \$500 \text{,} 000$$

could be updated to

$$\$100 \text{,} 000 \leq {\sum }_{i = 1}^{n} {X}_{i} + {X}_{fake} \leq \$500 \text{,} 000.$$

The facility employs the marketing optimization technique described above (and further described below) using the fake spend and the updated constraints to determine an allocation of resources, including an allocation to a budget surplus, that provides an optimal (or near optimal) revenue.

In some embodiments, the facility determines an allocation of resources that will provide a minimal (or near minimal) total target miss for a given budget, a given set of response models, and a given set of revenue targets. A target miss is the difference between a revenue target and a corresponding revenue prediction for a set of spends based at least in part on a response model. If the predicted or actual revenue is greater than or equal to the target, then there is no target miss (i.e., the target miss is 0). A total target miss is the sum of a set of target misses. For example, a company may expect to collect or target $500,000 in revenue from in-store sales and $750,000 in revenue from online sales and may allocate resources to marketing efforts to achieve these goals. Using corresponding response models (i.e., an in-store revenue response model and an online revenue response model) and a set of spends, the target misses can be calculated. For example, if the models predict, for a current spend, $300,000 in revenue from in-store sales and $700,000 in revenue from online sales, the company would miss its in-store revenue target by $200,000 and its online revenue target by $50,000, with a total target miss of $250,000. The facility takes advantage of an iterative application of the Dorman-Steiner rule (discussed above and further discussed below) along with optimization techniques, such as a gradient descent method, a bundle level method (further discussed below), or other suitable methods, to find an allocation of resources that, for a given set of revenue response model and associated targets, provides a minimal (or near minimal) total target miss. The facility repeatedly generates sets of spends and tests those spends against the targets. If a newly generated set of spends does not result in a total target miss that is less than the total target miss for a previously generated set of spends by at least a predetermined threshold, then the new set of spends are provided as an optimal (or near optimal) set of spends and the resulting target miss is provided as a minimal (or near minimal) target miss. The predetermined threshold can be specified, for example, by a user or by the facility itself. The nearer the predetermined threshold is to zero, the more likely a final set of new spends will have a minimal target miss. “Near minimal” refers to an improvement between target misses for different sets of spends that satisfies the predetermined threshold.

FIG. 1 is a block diagram illustrating an environment 100 in which a facility in accordance with an embodiment of the disclosed technology may operate. In this example, environment 100 includes server computer 110, customer computers 130, and network 140. Server computer 110 includes facility 120 comprising a create constraint tree component 121, an allocate component 122, an approximate component 123, a profit component 124, a hit-target component 125, a gradient descent component 126, a bundle level component 127, and a spend data store 128. The construct constraint tree component 121 is invoked to generate a constraint tree based at least in part on a set of constraints, each constraint including a lower bound, an upper bound, and one or more spend categories. The allocate component 122 is invoked to determine a valid allocation of resources (i.e., an allocation of resources that conforms to a particular set of constraints) for a given response model that will result in an optimal (or near optimal) level of output for the response model. The approximate component 123 is invoked to generate a set of spends based at least in part on a constraint tree node and its associated tree, a budget, a set of elasticities, and another set of spends. The profit component 124 is invoked to determine a valid allocation of resources (i.e., consistent with a given set of constraints) that provides an optimal (or near optimal) profit level. The hit-target component 125 is invoked to find the allocation of resources that reduces the total target miss for a given budget and set of response models to a minimal (or near minimal) level. The gradient descent component 126 is invoked to generate or update a set of spends based at least in part on a budget, a constraint tree, a set of revenue response models (one for each revenue type), and a set of targets (one for each revenue type). The bundle level component 127 is invoked to generate or update a set of spends based at least in part on a budget, a constraint tree, a set of revenue response models (one for each revenue type), and a set of targets (one for each revenue type). Spend data stores 118 and 131 store spend information, such as various resource allocations over time, spend schedules, updates schedules and so on. In some embodiments, components of the facility 120 may be distributed between the server computer 110 and the client computers 130. For example, instances of any of the constraint tree component 121, the allocate component 122, the approximate component 123, the profit component 124, the hit-target component 125, the gradient descent component 126, and/or the bundle level component 127 may reside at one or more customer computers 130. In some embodiments, communication between computers may occur via the network 140 or directly via wired or wireless communication connection (e.g., radio frequency, WiFi, BLUETOOTH).

The computing devices on which the disclosed systems are implemented may include a central processing unit, memory, input devices (e.g., keyboard and pointing devices), output devices (e.g., display devices), and storage devices (e.g., disk drives). The functions or algorithms described herein are implemented in hardware, and/or software in embodiments. The software comprises computer executable instructions on computer readable media. Non-transitory computer-readable media include tangible media such as hard drives, CD-ROMs, DVD-ROMS, and memories such as ROM, RAM, and Compact Flash memories that can store instructions. Signals on a carrier wave such as an optical or electrical carrier wave are examples of transitory computer-readable media. Further, such functions correspond to modules, which are software, hardware, firmware, or any suitable combination thereof. Multiple functions are performed in one or more modules as desired, and the embodiments described are merely examples. A digital signal processor, ASIC, microprocessor, or any other suitable type of processor operating on a system, such as a personal computer, server computer, supercomputing system, a router, or any other device capable of processing data including network interconnection devices executes the software. Instructions, data structures, and message structures may be transmitted via a data transmission medium, such as a signal on a communications link and may be encrypted. Various communications links may be used, such as the Internet, a local area network, a wide area network, a point-to-point dial-up connection, a cell phone network, and so on.

The disclosed technology may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

Many embodiments of the technology described herein may take the form of computer-executable instructions, including routines executed by a programmable computer. Those skilled in the relevant art will appreciate that aspects of the technology can be practiced on computer systems other than those shown and described herein. Embodiments of the technology may be implemented in and used with various operating environments that include personal computers, server computers, handheld or laptop devices, multiprocessor systems, microprocessor-based systems, programmable consumer electronics, digital cameras, network PCs, minicomputers, mainframe computers, computing environments that include any of the above systems or devices, and so on. Moreover, the technology can be embodied in a special-purpose computer or data processor that is specifically programmed, configured or constructed to perform one or more of the computer-executable instructions described herein. Accordingly, the terms “computer” or “system” as generally used herein refer to any suitable data processor and can include Internet appliances and handheld devices (including palmtop computers, wearable computers, cellular or mobile phones, multi-processor systems, processor-based or programmable consumer electronics, network computers, mini computers and the like). Information handled by these computers can be presented at any suitable display medium, including a CRT display or LCD.

The technology can also be practiced in distributed environments, where tasks or modules are performed by remote processing devices that are linked through a communications network. In a distributed computing environment, program modules or subroutines may be located in local and remote memory storage devices. Aspects of the technology described herein may be stored or distributed on computer-readable media, including magnetic or optically readable or removable computer disks, as well as distributed electronically over networks. Data structures and transmissions of data particular to aspects of the technology are also encompassed within the scope of the technology.

FIG. 2A is a data structure diagram illustrating a set of constraints in accordance with an embodiment of the disclosed technology. In this example, data structure 280 contains four constraints 281, 282, 283, and 284. Constraint 281 is associated with four spends: spend₁, spend₂, spend₃, and spend₄ and has a lower bound of 20 and an upper bound of 100 (e.g., dollars). Thus, the maximum allocation of resources to the sum of spend₁+spend₂+spend₃+spend₄ should be 100, and the minimum allocation of resources to this sum should be 20. Constraint 282 is associated with two spends, spend₁ and spend₂ and has a lower bound of 10 and an upper bound of 50. Constraint 283 is associated with one spend, spend₂, and has a lower bound of 5 and an upper bound of 25. Constraint 284 is associated with one spend, spend₄, and has a lower bound of 5 and an upper bound of 40. One skilled in the art will recognize that while FIG. 2A provides an illustration that is easily comprehensible by a human reader, the constraint information may be stored using any suitable data structure and/or suitable data organization techniques.

FIG. 2B is a flow diagram illustrating the processing of a construct constraint tree component in accordance with an embodiment of the disclosed technology. The construct constraint tree component generates a constraint tree based at least in part on a set of constraints, each constraint having an associated lower bound, upper bound, and one or more spends (the lower bound and upper bound represent the constraints on the sum of the associated spend categories). The lower bound corresponds to the least amount that should be allocated to the associated spend or combination of spends, while the upper bound corresponds to the most that should be allocated to the associated spend or combination of spends. In other words, the lower bound and upper bound establish a range of values for allocations to a particular spend or combination of spends that are acceptable for, for example, a marketing department or other budget setting entity. In block 205, the component sorts the constraints from constraints with the largest number of associated spends to constraints with the smallest number of associated spends. For example, a constraint on spend₁+spend₂ has two associated spends (spend₁ and spend₂) while a constraint on

$${\sum }_{i = 1}^{n} {X}_{i}$$

has n associated spend categories (spend₁, . . . , spend₂). In block 210, the component selects the next constraint, starting with the constraint having the largest number of associated spends. In decision block 215, if a root node for the constraint tree has already been created, then the component continues at decision block 225, else the component continues at block 220. In block 220, the component uses the selected constraint to create the root node and then continues at decision block 255. In decision block 225, if the number of spends associated with the current constraint are not less than the number of spends associated with the root node, then the component returns an error message, else the component continues at block 230. In block 230, the component identifies all potential parent nodes for the selected constraint. The potential parent nodes include all nodes that include any of the spends associated with the current constraint and that do not have any child nodes that include any of the spends associated with the currently selected constraint. For example, in FIG. 2C node 292 would qualify as a potential parent node for a constraint on spend₁. Although node 291 also includes or is associated with spend₁, node 291 would not qualify as a potential parent node for a constraint associated with spend₁ because node 291 has a child node that includes spend₁ (i.e., node 292). In decision block 235, if the number of identified potential parent nodes is not equal to one, then the component returns an error message, else the component continues at decision block 240. In decision block 240, if the identified potential parent node does not include all of the spends associated with the current constraint, then the component returns an error message, else the component continues at block 245. In block 245, the component uses the selected constraint to create a new node. In block 250, the component sets the new node as a child of the identified potential parent node. In decision block 255, if there are additional constraints, then the component loops back to block 210 to select the next constraint, else the component returns the constraint tree and completes. In some embodiments, the facility creates a node using a constraint by, for example, instantiating a node object and storing in the node object information corresponding to the associated spend, lower bound, and upper bound.

FIG. 2C is a display diagram illustrating a constraint tree in accordance with an embodiment of the disclosed technology. Constraint tree 290 was generated based at least in part on the constraints provided in data structure 280 (FIG. 2A) and includes root node 291, corresponding to constraint 281 and nodes 292-294, each corresponding one of the constraints 282-284. One skilled in the art will recognize that while FIG. 2C provides an illustration that is easily comprehensible by a human reader, the actual information may be stored using different data structures and/or data organizations.

FIG. 3 is a flow diagram illustrating the processing of an allocate component in accordance with an embodiment of the disclosed technology. The allocate component is invoked to determine a valid allocation of resources (i.e., an allocation of resources that conforms to a particular set of constraints) for a given response model that will result in an optimal (or near optimal) level of output for the response model (F). In block 310, the component initializes a counting variable k to one. In block 320, the component determines the current vector or set of spends (currentspends). The initial currentspends correspond to how a particular entity is currently allocating resources or how the entity has allocated resources in the past. For example, a company or client may provide an indication of how they are (or have) allocated resources to different channels (e.g., marketing channels). This information may be retrieved periodically and may be stored for later use. In block 330, the component determines elasticities for each of the current spends X[1], . . . , X[n] based at least in part on, for example, the following formula:

$$elasticities [ i ] = \frac{X [ i ]}{F ( X [ 1 ] , … , X [ n ] )} \times \frac{\partial F ( {X}_{1} , … , {X}_{n} )}{\partial {X}_{i}} ,$$

where F represents a response model, X[1], . . . , X[n] represents a set of spends (and the inputs to the response model) (e.g., currentspends), and

$$\frac{\partial F ( {X}_{1} , … , {X}_{n} )}{\partial {X}_{i}}$$

represents the partial derivative of the response model with respect to a particular spend. Each elasticity represents the change in the outcome of the response model due to a change in a particular spend. In block 340, the component invokes an approximate component. The approximate component generates a new set of spends (newspends) based at least in part on the root node of the constraint tree, a “maxspend” (i.e., the upper bound of the root node), the current spends (currentspends), and the calculated elasticities (elasticities). The approximate component, as discussed in further detail below with respect to FIG. 4, generates newspends based at least in part on an iterative Dorfman-Steiner algorithm or its variants. In decision block 350, if k is less than K (a predetermined maximum number of iterations), then the component continues at decision block 360, else the component returns the generated spends (newspends). In decision block 360, if the invocation of the approximate component results in convergence, then the component returns the generated spends (newspends), else the component continues at block 370. Convergence occurs, for example, when either

∥newspends−currentspends∥≦ε

or

∥F(newspends)−F(currentspends)∥≦ε′.

where each of ε and ε′ are predetermined tolerances or thresholds. In other words, the allocation component continues processing unless either the distance between newspends (a vector of spends) and currentspends (a vector of spends) is less than or equal to a predetermined threshold or if the difference between the output of the response model with newspends as inputs and the output of the response model with currentspends as inputs is less than or equal to a predetermined threshold or the number of iterations (k) reaches a predetermined maximum number (K). The lower the predetermined thresholds, the more likely the component will provide an optimal allocation of resources (i.e., set of spends). In block 370, the component replaces currentspends with newspends. In block 380, the component increments the counting variable k by 1 (k=k+1) and then loops back to block 330 to determine the elasticities for the updated currentspends.

FIG. 4 is a flow diagram illustrating the processing of an approximate component in accordance with an embodiment of the disclosed technology. The approximate component is invoked to generate a set of spends (newspends) based at least in part on a constraint tree node (node) and its associated tree, a budget, a set of elasticities, and a set of spends (spends). In block 405, the component solves for an adjustment factor, v based at least in part on, for example, the following formula:

$${b}_{n} ( v ) = {\sum }_{i = 1}^{K} max \{ {n}_{1 b} , min \{ {n}_{ub} , {b}_{{n}_{i}} ( v ) \} \} + {\sum }_{spend ∈ 〈 {n}_{spends} 〉}^{ } g ( elasticities [ spend ] , spend , currentspends ) \cdot v$$

where n is a node within a constraint tree, K represents the number of n's children, n_{lb} represents n's lower bound, n_{ub} represents n's upper bound, nᵢ represents a child of n, and [symbol] n_{spends} [symbol] comprises all of the spends within n that are not part of or associated with any of n's children, and function g is a user specified function Examples of function g include, for example,
a. g(elasticities[i], i, currentspends)=elasticities[i], which gives the Dorfman-Steiner rule
b.

$$g ( elasticities [ i ] , i , currentspends ) = elasticities [ i ] \frac{r + \frac{\partial F ( currentspends )}{\partial {X}_{i}}}{\frac{\partial F ( currentspends )}{\partial {X}_{i}}} ,$$

where r is a user-defined constant, X represents the variables of function F, and example function “b” represents a variant of the Dorfman-Steiner rule. Using node 292 as an example, K would be 1, n_{lb} would be 10, n_{ub} would be 50, n₁ would be node 293 (in this example node 292 only has one child), and [symbol] n_{spends} [symbol] comprises spend₁. To solve for v, the component sets b_{node}(v) (i.e., the above bₙ(v) formula with the received node node as n) equal to the received budget and then solves for v. In some embodiments, the component solves for v using a root-finding algorithm, such as Brent's method, a bisection method, a secant method, an interpolation method, or another suitable root-finding algorithm. In block 410, the component initializes j, a counting variable, to one. In blocks 415-430, the component loops through each of the spends to determine whether a new allocation amount should be calculated for the spend. In decision block 415, if spendⱼ is a member of node then the component continues at decision block 420, else the component continues at decision block 430. In decision block 420, if spendⱼ is a member of any child node of node then the component continues at decision block 430, else the component continues at block 425. In block 425, the component calculates a new allocation amount for the j^{th} spend based at least in part on, for example, the following formula,

newspends[j]=g(elasticities[j],j,currentspend)·v′

where g represents a user-specified function, such as example equations “a” and “b” discussed above. In decision block 430, if there are additional spends, then the component continues at block 435, else the component continues at block 440. In block 435, the component increments j and then loops back to decision block 415. In decision block 440, if node has any child nodes, then the component continues at block 445, else the component returns the calculated newspends. In blocks 445-460, the component loops through each of node's children and recursively invokes the approximate component to continue the calculation of newspends. In block 450, the component calculates b based at least in part on, for example, the following formula:

b=max{node_{lb},min{node_{ub},b_{child}(v)}}

where node_{lb} represents the lower bound of node, node_{ub} represents the upper bound of node, v represents the adjustment factor, and child represents the currently selected child node. In block 455, the component recursively invokes the approximate component to update newspends based at least in part on the currently selected child node child, the calculated value of b, the modified newspends, and the elasticities (elasticities). In other words, the component invokes the approximate component to continue calculating spends for newspends. In block 460, the component selects the next child node of node, if any, and then loops back to block 445. If all of the child nodes have been processed, the component returns the calculated newspends. Accordingly, newspends can be calculated without determining a second derivative for the model.

FIG. 5 is a flow diagram illustrating the processing of a profit component in accordance with an embodiment of the disclosed technology. The profit component is invoked to determine the allocation of resources that provides an optimal (or near optimal) level of profits from among the valid allocations of resources (i.e., consistent with a given set of constraints). The profit component creates a fake “spend,” modifies an existing constraint tree with the fake spend, and then invokes the allocate component based at least in part on the modified constraint tree. The fake spend represents resources that will not be allocated or otherwise spent on, for example, advertising. In other words, these resources are saved to create a budget surplus. In block 510, the component updates the constraint tree by adding the fake spend spend_{fake} to the root node. Using the constraint tree in FIG. 2C for example, the root node would be modified from

spend₁+spend₂+spend₃+spend₄

to

spend₁+spend₂+spend₃+spend₄+spend_{fake}.

In block 520, the component invokes the allocate component, passing to the allocate component the updated constraint tree. The component then returns the new spends provided by the allocate component. These spends represent the allocation of resources that provide an optimal (or near optimal) level of profits from among the possible allocations of resources.

FIG. 6 is a flow diagram illustrating the processing of a hit-target component in accordance with an embodiment of the disclosed technology. The hit-target component is invoked to find the allocation of resources that reduces the total target miss to a minimal (or near minimal) level. The hit-target component generates a set of spends corresponding to the allocation of resources that reduces the amount of target misses to an optimal (or near optimal) level based at least in part on a constraint tree, revenue response models, and revenue targets. In block 604, the component initializes b̅ as the upper bound of the total budget based at least in part on, for example, the following formula:

$$\overline{b} = {max}_{spends ∈ Ω} {\sum }_{i}^{ } spend [ i ] ,$$

where spends[i] represents the i^{th} spend and Ω represents the set of feasible spends within a given set of constraints. In block 608, the component initializes b as the lower bound of the total budget based at least in part on, for example, the following formula:

$$\underline{b} = {max}_{spends ∈ Ω} {\sum }_{i}^{ } spend [ i ] ,$$

where spend[i] represents the i^{th} spend and Ω represents the set of feasible spends within a given set of budget constraints. In block 612, the component sets variable b, an iteration budget, equal to b̅. In block 616, the component calculates the best target miss, D, for the current iteration budget, the set of revenue response models, the revenue targets, and the constraints associated with the constraint tree, based at least in part on, for example, the following formula:

$$D = {min}_{{spend ∈ Ω}_{\sum spends = \overline{b}}} {\sum }_{j = 1}^{J} max \{ 0 , {T}_{j} - {F}_{j} ( spends [ 1 ] , … , spends [ n ] ) \}$$

where spends[i] represents the i^{th} spend of the set of spends spends (for example, spends[1] represents the first spend in the set of spends spends while spends[3] represents the third spend in the set of spends spends, Ω represents the set of feasible spends within a given set of constraints, Tⱼ represents a revenue target for the j^{th} revenue type, Fⱼ represents a revenue response model for the j^{th} revenue type, and J represents the number of revenue types. In decision block 620, if the component is applying a gradient descent method for reducing total target miss, then the component continues at block 628 and invokes a gradient descent component, else the component continues at block 624 and invokes a bundle level component. Each of the gradient descent and bundle level components generates or updates a set of spends based at least in part on a budget, a constraint tree, a set of revenue response models, and a set of revenue targets. The gradient descent and bundle level components each provide a set of spends and a set of weighted elasticities (we). One skilled in the art will recognize that other suitable optimizing components could be employed. In decision block 632, if the target miss for the spends generated or updated in block 624 or block 628 is equal to the best target miss, D, then the component continues at block 648, else the component continues at block 636. The target miss for the generated or updated spends can be calculated based at least in part on, for example, the following formula:

$${min}_{{spend ∈ Ω}_{\sum spends = b}} {\sum }_{j = 1}^{J} max \{ 0 , {T}_{j} - {F}_{j} ( spends [ 1 ] , … , spends [ n ] ) \} ,$$

where spends[i] represents the i^{th} spend of the generated or updated set of spends spends (e.g., spends[1] represents the first spend), Ω represents the set of feasible spends within a given set of constraints, Tⱼ represents a revenue target for the j^{th} revenue type, Fⱼ represents a revenue response model for the j^{th} revenue type, and J represents the number of revenue types. In some embodiments, the target miss for the generated or updated spends can be calculated based at least in part on, for example, the following formula:

$${max}_{w ∈ {[ 0 , 1 ]}^{J}} {min}_{{spend ∈ Ω}_{\sum spends = b}} ( {\sum }_{j = 1}^{J} weights [ j ] * ( \begin{matrix}{T}_{j} - {F}_{j} ( spend [ 1 ] \\ … spends [ n ] )\end{matrix} ) ) ,$$

where spends[i] represents the i^{th} spend of the generated or updated set of spends spends, Ω represents the set of feasible spends within a given set of constraints, weights[j] represents the j^{th} weight of the set of weights provided by either the gradient descent component (box 628) or the bundle level component (box 624), Tⱼ represents a revenue target for the j^{th} revenue type, Fⱼ represents a revenue response model for the j^{th} revenue type, and J represents the number of revenue types.
In blocks 636-644, the component updates the iteration budget and the lower bound for the budget. In block 636, the component stores (e.g., temporarily) the current lower bound b. In block 640, the component replaces the current lower bound b with the iteration budget b. In block 644, the component replaces the iteration budget with the average of the current upper bound b̅ and the previous lower bound value (i.e., the lower bound temporarily stored in block 636).

In block 648, the component calculates elasticities for each spend of the generated set of spends, newspends, based at least in part on, for example, the following formula:

$$elasticities [ i ] = \frac{X [ i ]}{{\sum }_{j}^{ } {F}_{j} ( X [ 1 ] , … , {X}_{n} )} \times \frac{{\sum }_{j} \partial {F}_{j} ( {X}_{1} , … , {X}_{n} )}{\partial {X}_{i}}$$

where Fⱼ the response model associated with the j^{th} revenue type, X₁, . . . , Xₙ represents a set of spends,

$$\frac{\partial {F}_{j} ( {X}_{1} , … , {X}_{n} )}{\partial {X}_{i}}$$

represents the partial derivative of the response model associated with the j^{th} revenue type with respect to the i^{th} spend of a set of spends X. In block 652, the component initializes k, a counting variable, to one. In decision block 656, if we[k] (i.e., the weighted elasticity for the k^{th} spend of newspends) is less than or equal to the product of C and elasticities[k], the elasticity for the k^{th} spend of newspends, then the component continues at block 660, else the component continues at decision block 664. C is a predetermined value that is used to vary the probability that a spend will be cut. As C increases, the probability that a spend will be cut increases and, conversely, as C gets closer to 0, the probability that a spend will be cut decreases. In block 660, the component cuts or trims the k^{th} spend of newspends. In decision block 664, if there are additional spends of newspends to be processed, then the component continues at block 668, else the component continues at block 672. In block 668, the component increments k and then loops back to decision block 656 to test another set of elasticities.

In block 672, the component calculates the total budget reduction (Δb) resulting from the spend cuts (block 660), based at least in part on, for example, the following formula:

$$Δ b = {\sum }_{i ∈ cut spends}^{ } newsspends [ i ] - {min}_{spends ∈ Ω} {\sum }_{i ∈ cut spends}^{ } spends [ i ] .$$

Δb represents the maximum spend cut that is consistent with the constraints. In block 676, the component stores (e.g., temporarily) the current iteration budget b. In block 680, the component updates the iteration budget b based at least in part on, for example, the following formula:

$$b = min \{ \frac{\overline{b} + \underline{b}}{2} , \overline{b} + Δ b \} .$$

In block 684, the component replaces the iteration budget upper bound with the previous iteration budget (i.e., the value temporarily stored in block 676). In decision block 688, if b̅−b≦θ, where θ is a predetermined threshold, then the component returns newspends, else the component loops back to block 620 to continue processing spends for the updated iteration budget.

FIG. 7 is a flow diagram illustrating the processing of a gradient descent component in accordance with an embodiment of the disclosed technology. The gradient descent component is invoked to generate or update a set of spends based at least in part on a budget (budget), a constraint tree, a set of revenue response models (F) (one for each revenue type), and a set of targets (T) (one for each revenue type). In block 704, the component determines the current set of spends (currentspends). The initial currentspends correspond to how a particular entity is currently allocating resources or how the entity has allocated resources in the past. For example, a company or client may provide an indication of how they are allocating (or have allocated) resources to different channels (e.g., marketing channels). This information may be retrieved periodically and may be stored for later use. In blocks 708-724, the component loops through each of the revenue types and initializes a weight (weights), an upper bound (upperbounds), and a lower bound (lowerbounds) for the revenue type. In this example, the component initializes each weight to 1 (block 712), each upper bound to 1 (block 716), and each lower bound to 0 (block 720). In block 724, the component loops back to select the next revenue type, if any. In block 728, the component calculates a current best miss value (bestmiss) based at least in part on the current spends (currentspends) based at least in part on, for example, the following formula:

$${\sum }_{j = 1}^{J} max \{ 0 , {T}_{j} - {F}_{j} ( currentspends [ 1 ] , … , currentspends [ n ] ) \} .$$

where currentspends[i] represents the i^{th} spend of currentspends, Ω represents the set of feasible spends within a given set of budget constraints, Tⱼ represents a revenue target for the j^{th} revenue type, Fⱼ represents a revenue response model for the j^{th} revenue type, and J represents the number of revenue types.

In block 732, the component calculates weighted elasticities (we) for each revenue type based at least in part on, for example, the following formula:

$$we [ i ] = \frac{X [ i ]}{{\sum }_{j}^{ } weights [ j ] * {F}_{j} ( X [ 1 ] , … , X [ n ] )} \times \frac{{\sum }_{j}^{ } weights [ j ] * \partial {F}_{j} ( {X}_{1} , … , {X}_{n} )}{\partial {X}_{i}} ,$$

where Fⱼ represents the j^{th} revenue response model, X₁, . . . , Xₙ represents the spends of currentspends, weightⱼ represents the weight associated with the j^{th} revenue type,

$$\frac{\partial weights [ j ] * {F}_{j} ( {X}_{1} , … , {X}_{n} )}{\partial {X}_{i}}$$

represents the partial derivative of the revenue response model associated with the j^{th} revenue type with respect to the i^{th} spend of a set of spends X times the weight associated with the j^{th} revenue type. In block 736, the component invokes an approximate component. The approximate component generates a new set of spends (newspends) based at least in part on the constraint tree, the received budget, the current spends (currentspends), and the calculated weighted elasticities (we). In blocks 740-764, the component loops through the revenue types to determine whether the upper bound for each revenue type is to be updated and, if so, the component updates the upper bound. In decision block 744, if the revenue for the currently selected revenue type (based at least in part on the revenue response model Fᵣₑᵥₑₙᵤₑ and generated newspends) would meet or exceed the target for the currently selected revenue type (Tᵣₑᵥₑₙᵤₑ), then the component continues at block 748, else the component continues at block 756. In block 748, the component updates or replaces the upper bound for the currently-selected revenue type (upperbounds[revenue]) with the weight for the currently selected revenue type (weights[revenue]). In block 752, the component updates the weight for the currently selected revenue type (weights[revenue]) based at least in part on, for example, the following formula:

$$max \{ \begin{matrix}0 , \\ min \{ \begin{matrix}\frac{lowerbound s [ revenue ] + weights [ revenue ]}{2} , \\ weights [ revenue ] - \frac{{T}_{revenue} - {F}_{revenue} ( newspends )}{{T}_{revenue}}\end{matrix} \}\end{matrix} \}$$

where Tᵣₑᵥₑₙᵤₑ represents a target for a particular revenue type and Fᵣₑᵥₑₙᵤₑ(newspends) represents the outcome of the revenue response model associated with a particular revenue type using newspends as input. In block 756, the component updates or replaces the lower bound for the currently selected revenue type (lowerbounds[revenue]) with the weight for the currently selected revenue type (weights[revenue]). In block 760, the component updates the weight for the currently selected revenue type (weights[revenue]) based at least in part on, for example, the following formula:

$$min \{ \begin{matrix}1 , \\ max \{ \begin{matrix}\frac{upperbounds [ revenue ] + weights [ revenue ]}{2} , \\ weights [ revenue ] + \frac{{T}_{revenue} - {F}_{revenue} ( newspends )}{{T}_{revenue}}\end{matrix} \}\end{matrix} \}$$

where Tᵣₑᵥₑₙᵤₑ represents a target for a particular revenue type and Fᵣₑᵥₑₙᵤₑ(newspends) represents the outcome of the revenue response model associated with a particular revenue type when applied to newspends. In block 764, the component loops back to select the next revenue type, if any. In block 768, the component calculates a new total miss value (newmiss) based at least in part on the generated spends (newspends) based at least in part on, for example, the following formula:

$${\sum }_{j = 1}^{J} max \{ 0 , {T}_{j} - {F}_{j} ( newspends [ 1 ] , … , newspends [ n ] ) \} ,$$

where newspends[i] represents the i^{th} spend of newspends, Tⱼ represents a revenue target for the j^{th} revenue type, Fⱼ represents a revenue response model for the j^{th} revenue type, and J represents the number of revenue types. In decision block 772, if newspends would result in all of the revenue response models meeting or exceeding the associated targets (i.e., if Fᵣₑᵥₑₙᵤₑ(newspends)≧Tᵣₑᵥₑₙᵤₑ for all revenue types), then the component returns the generated spends (newspends) and weighted elasticities (we), else the component continues at decision block 776. In decision block 776, if the difference between be and newmiss does not exceed a predetermined threshold u, then the component returns newspends, we, and weights, else the component continues at decision block 780. In decision block 780, if bestmiss is greater than newmiss, then the component continues at block 784, else the component continues at block 788. In block 784, the component replaces bestmiss with newmiss. In block 788, the component updates or replaces currentspends with newspends and then loops back to block 732 to calculate weighted elasticities based at least in part on the updated spends and weights.

FIG. 8 is a flow diagram illustrating the processing of a bundle level component in accordance with an embodiment of the disclosed technology. The bundle level component is invoked to generate or update a set of spends (newspends) based at least in part on a set of spends, a budget (budget), a constraint tree, a set of revenue response models (F) (one for each revenue type), and a set of targets (T) (one for each revenue type). In block 801, the component initializes n, a counting variable, to one. In block 805, the component initializes a set of weights (weights[1]) for each revenue type by setting each weight equal to one. In this example, weights represents multiple sets of weights, one set for each loop through block 820-870. Thus, weights[n] corresponds to a particular set of weights (the n^{th} set of weights) while weights[n] [m] represents a particular weight within a set of weights (the m^{th} weight of the n^{th} set of weights).

In block 810, the component determines the current set of spends (currentspends). The initial currentspends correspond to how a particular entity is currently allocating resources or how the entity has allocated resources in the past. For example, a company or client may provide an indication of how they are (or have) allocated resources to different channels (e.g., marketing channels). This information may be retrieved periodically and may be stored for later use. In block 815, the component sets S[n] equal to currentspends. Thus, S (labeled “spends” in FIG. 8) is a set of sets of spends such that each entry of S (e.g., S[1] or S[2]) is a set of spends, and S[n] [p] represents a particular spend. In block 817, the component initializes candidatespends[1] to currentspends. The set candidatespends, like S, is a set of a set of spends. In block 820, the component calculates weighted elasticities (we) for each revenue type based at least in part on, for example, the following formula:

$$we [ i ] = \frac{X [ i ]}{{\sum }_{j} weights [ n ] [ j ] * {F}_{j} ( X [ 1 ] , … , X [ n ] )} \times \frac{{\sum }_{j} weights [ n ] [ j ] * \partial {F}_{j} ( {X}_{1} , … , {X}_{m} )}{\partial {X}_{i}} ,$$

where Fⱼ represents the j^{th} revenue response model, X₁, . . . , Xₘ represents a set of m spends,

$$\frac{\partial weights [ n ] [ j ] * {F}_{j} ( {X}_{1} , … , {X}_{m} )}{\partial {X}_{i}}$$

represents the partial derivative of the revenue response model associated with the j^{th} revenue type with respect to the i^{th} spend of a set of spends X times the n^{th} weight associated with the j^{th} revenue type. In block 825, the component invokes an approximate component. The approximate component generates a new set of spends (S[n+1]) based at least in part on the root node (root) of the constraint tree, the received budget, spends (S[n]), and the calculated weighted elasticities (we). In decision block 830, if the target miss for S[n+1] is less than the target miss for candidatespends[n], then the component continues at block 840, else the component continues at block 835. As discussed above, the target miss for a set of spends X, a set of revenue response models F, and a set of targets T can be calculated based at least in part on, for example, the following formula:

$${\sum }_{j = 1}^{J} max \{ 0 , {T}_{j} - {F}_{j} ( X [ 1 ] , … , X [ n ] ) \} ,$$

where J represents the number of revenue types. In block 835, the component updates or replaces S[n+1] with the candidatespends[n]. In block 840, the component constructs H̅[n] (S[n+1]), a piecewise linear function approximation to the target miss function with respect to the S[n+1], based at least in part on, for example, the following piecewise linear function:

$${max}_{l < v \leq n} {{\sum }_{j = 1}}^{J} ( weights [ v ] [ j ] * ( {T}_{j} - {F}_{j} ( S [ v ] ) ) ) - {( {{\sum }_{j = 1}}^{J} weights [ v ] [ j ] * \frac{\partial {F}_{j} ( S [ v ] )}{\partial S} )}^{T} * ( S - S [ v ] )$$

where J represents the number of revenue types, S[v] represents a set of spends, and

$${( {{\sum }_{j = 1}}^{J} weights [ v ] [ j ] * \frac{\partial {F}_{j} ( S [ v ] )}{\partial S} )}^{T}$$

represents the transposition of

$$( {{\sum }_{j = 1}}^{J} weights [ v ] [ j ] * \frac{\partial {F}_{j} ( S [ v ] )}{\partial S} ) .$$

In block 845 component constructs H[n] (S) based at least in part on, for example, the following piecewise linear function:

$${min}_{l < v \leq n} {{\sum }_{j = 1}}^{J} weights [ v ] [ j ] * ( {T}_{j} - {F}_{j} ( S [ v ] ) ) ,$$

where J represents the number of revenue types and S represents a set of spends. In block 850, the component calculates the “level” (δ), or minimum gap between H̅[n] (S) and H[n] (weights) based at least in part on, for example, the following formula:

$${min}_{S ∈ Ω , weights ∈ [ 0 , 1 ]} \overline{H} [ n ] ( S ) - \underline{H} [ n ] ( weights ) .$$

In decision block 855, if δ is less than φ, predetermined tolerance or threshold, then the component returns S[n+1], we, and weights, else the component continues at block 860. In block 860, the component generates candidatespends[n+1] and weights[n+1] based at least in part on, for example, the following formula:

$$( candidatespends [ n + 1 ] , weights [ n + 1 ] ) = {arg min}_{S ∈ Ω , weights ∈ [ 0 , 1 ] J} ‖ ( S , weights ) - ( S [ n ] , weights [ n ] ) ‖ ,$$

where J represents a number of revenue types, and Ω represents the set of feasible spends within a given set of budget constraints. The above formula for generating candidatespends[n+1] and weights[n+1] is subject to:

$$\overline{H} [ n ] ( S ) - \underline{H} [ n ] ( weights ) \leq \frac{δ}{2} , \\ where$$

$$‖ X , w ‖ = \sqrt{ω {\sum }_{i = 1}^{I} {X [ i ]}^{2} + {\sum }_{j = 1}^{J} W [ j ]} , and$$

$$ω = \frac{\sqrt{{\sum }_{i = 1}^{I} {( \frac{\partial \overline{H} [ 1 ]}{\partial S [ 1 ] [ i ]} )}^{2}}}{\sqrt{{\sum }_{j = 1}^{J} {( \frac{\partial \underline{H} [ 1 ]}{\partial w [ 1 ] [ j ]} )}^{2}}} \sqrt{\frac{J}{4 I ( I - 1 )}}$$

where X represents a set of spends, w represents a set of weights, I represents the number of spends in X, J represents the number of weights in w, T represents a set of targets, and F represents a set of revenue response models. In block 865, the component removes the linear constraints within

$$\overline{H} [ n ] ( S ) - \underline{H} [ n ] ( weights ) \leq \frac{δ}{2}$$

that have zero Lagrangian multipliers (standard output from quadratic programming solvers, such as Interior Point OPTimizer (IPOPT) or other suitable optimizers). In block 870, the component increments n by 1 and then loops back to block 820 to calculate new weighted elasticities.

From the foregoing, it will be appreciated that specific embodiments of the technology have been described herein for purposes of illustration, but that various modifications may be made without deviating from the disclosure. As used herein, indexes into a set of objects (e.g., an array of values or set of spends) are represented using either bracket notation (e.g., set[index]) or subscript notation (e.g., set_{index}), such that the first object of a set of n objects can be represented as either set[1] or set₁ and the last or n^{th} object as either set[n] or setₙ. The facility can include additional components or features, and/or different combinations of the components or features described herein. Additionally, while advantages associated with certain embodiments of the new technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

I/We claim:

1. A method for calculating an allocation of resources, the method comprising:
receiving a plurality of constraints, each constraint having an associated spend category, an associated lower bound, and an associated upper bound;
generating a constraint tree comprising a plurality of constraint tree nodes, each node corresponding to one of the plurality of constraints;
for each of a plurality of spend categories associated with a marketing response model,
determining a first elasticity for the spend category, and
determining a current spend for the spend category;
determining a first proposed spend for each of the plurality of spend categories based at least in part on the determined first elasticities and a Cobb-Douglas approximation to the marketing response model;
comparing the first proposed spends to the current spends determined for each of the spend categories; and
in response to determining that a difference value based at least in part on the comparing is greater than a predetermined threshold,
for each of a plurality of spend categories associated with the marketing response model,
determining a second elasticity for the spend category, and
determining a second spend based at least in part on one of the determined second elasticities and a Cobb-Douglas approximation to the marketing response model, and
comparing the second proposed spends to the first proposed spends.

2. The method of claim 1, wherein determining the first proposed spends comprises:
for each of a plurality of nodes of the constraint tree,
for each of a plurality of spend categories,
determining whether the spend category is a member of the node,
in response to determining that the spend category is not a member of the node,
determining whether the spend category is a member of a child node of the node, and
in response to determining that the spend category is not a member of a child node of the node, generating a proposed spend for the spend category based at least in part on the first elasticity determined for the spend category and an adjustment factor.

3. The method of claim 1, wherein the adjustment factor for a first node is determined based at least in part on,
$${b}_{n} ( v ) = {\sum }_{i = 1}^{K} max \{ {node}_{lb} , min \{ {node}_{ub} , {b}_{{node}_{i}} ( v ) \} \} ,$$
wherein K represents the number of children of the first node, node_{lb} represents the lower bound associated with the first node, node_{ub} represents the upper bound associated with the first node, and nodeᵢ represents the ith child of the first node.

4. The method of claim 1 wherein the difference value is determined based at least in part on a distance between the first proposed spends and the current spends determined for each of the spend categories.

5. The method of claim 1, further comprising:
determining a budget based at least in part on a root node of the constraint tree.

6. The method of claim 1 wherein the difference value is determined based at least in part on a difference between an outcome of the marketing response model evaluated for the current spends determined for each of the spend categories and an outcome of the marketing response model evaluated for the first plurality of proposed spends.

7. The method of claim 1, further comprising:
prior to determining the first proposed spends,
creating a spend category corresponding to surplus budget, and
updating a node of the constraint tree to include the created spend category.

8. The method of claim 1 wherein determining at least one current spend for the spend category comprises receiving historical spend data.

9. The method of claim 1, wherein generating the constraint tree comprises:
sorting the received plurality of constraints;
generating a root node based on the first constraint of the sorted plurality of constraints; and
for each of a plurality of constraints,
determining whether the number of spend categories associated with the root node is greater than the number of spend categories associated with the constraint,
identifying at least one potential parent node for the constraint, and
determining whether the identified at least one potential parent node is associated with all of the spend categories associated with the constraint.

10. A computer-readable storage medium storing instructions that, if executed by a computing system having a processor, cause the computing system to perform a method comprising:
generating a constraint tree comprising a plurality of constraint tree nodes, each constraint tree node corresponding to a constraint having an associated spend category, an associated lower bound, and an associated upper bound;
for each of a plurality of spend categories associated with a marketing response model,
determining an elasticity, and
determining a current allocation;
determining a first proposed allocation for each of the spend categories based at least in part on the determined elasticities and a Cobb-Douglas approximation to the marketing response model;
comparing the first plurality of proposed allocations to the current allocations determined for each of the spend categories; and
in response to determining that a difference value based at least in part on the comparing is greater than a predetermined threshold, determining a second plurality of proposed allocations and comparing the second plurality of proposed allocations to the first proposed allocations.

11. The computer-readable storage medium of claim 10, determining at least one first proposed allocation comprises:
for each of a plurality of nodes of the constraint tree,
for each of a plurality of spend categories,
determining whether the spend category is a member of the node,
in response to determining that the spend category is not a member of the node,
determining whether the spend category is a member of a child node of the node, and
in response to determining that the spend category is not a member of a child node of the node, generating a proposed spend for the spend category based at least in part on the elasticity determined for the spend category and an adjustment factor.

12. The computer-readable storage medium of claim 10, wherein the adjustment factor for a first node is determined based at least in part on,
$${b}_{n} ( v ) = {\sum }_{i = 1}^{K} max \{ {node}_{lb} , min \{ {node}_{ub} , {b}_{{node}_{i}} ( v ) \} \} + {\sum }_{s ∈ 〈 {node}_{spends} 〉} g ( elasticites [ s ] , s , currentspend ) \cdot v$$
wherein K represents the number of children of the first node, node_{lb} represents the lower bound associated with the first node, node_{ub} represents the upper bound associated with the first node, elasticities represents the determined first elasticities, nodeᵢ represents the ith child of the first node, [symbol] node_{spends} [symbol] contains all of the spend categories associated with the first node that are not associated with any child of the first node and function g is a user specified function.

13. The computer-readable storage medium of claim 10 wherein the difference value is determined based at least in part on a distance between the first proposed spends and the current spends determined for each of the spend categories.

14. The computer-readable storage medium of claim 10 wherein the difference value is determined based at least in part on a difference between an outcome of the marketing response model evaluated for the current spends determined for each of the spend categories and an outcome of the marketing response model evaluated for the first proposed spends.

15. The computer-readable storage medium of claim 10, the method further comprising:
prior to determining the first proposed allocations,
creating an allocation category corresponding to surplus budget, and
updating a node of the constraint tree to include the created spend category.

16. The computer-readable storage medium of claim 10 wherein the first proposed allocations are determined without determining a second derivative for the marketing response model.

17. The computer-readable storage medium of claim 10, wherein generating the constraint tree comprises:
sorting a plurality of constraints;
generating a root node based on the first constraint of the sorted plurality of constraints; and
for each of a plurality of constraints,
determining whether the number of spend categories associated with the root node is greater than the number of spend categories associated with the constraint,
identifying at least one potential parent node for the constraint, and
determining whether the identified at least one potential parent node is associated with all of the spend categories associated with the constraint.

18. A system, comprising:
a component configured to receive, for each of a plurality of revenue types,
a revenue response model, and
a target;
a component configured to receive, for each of a plurality of spend categories associated with the revenue response models, a current spend for the spend category;
a component configured to generate, based at least in part on the received revenue response models, the received targets, the received current spends, and Cobb-Douglas approximations to the revenue response models, for each of the plurality of spend categories, a first proposed spend;
a component configured to determine a target miss for the generated first proposed spends; and
a component configured to, in response to determining that the target miss is not below a threshold, generate, based at least in part on the received revenue response models, the received targets, the first proposed spends, and Cobb-Douglas approximations to the revenue response models, for each of the plurality of spend categories, a second proposed spend.

19. The system of claim 18, wherein the component configured to determine the target miss for the generated first proposed spends is configured to,
for each of the plurality of revenue types,
determining an outcome, of the revenue response model corresponding to the revenue type, based at least in part on the first proposed spends, and
compare the determined outcome to the target received for the revenue type.

20. The system of claim 18, wherein the component configured to generate the first proposed spends comprises means for determining spends based at least in part on a gradient of at least one of the plurality of response models.
